(19) United States
(12) Patent Application Publication
(10) Pub. No.: US 2013/0110436 A1
(43) Pub. Date: May 2, 2013

(54) INSPECTION APPARATUS, PROCESSING APPARATUS, INFORMATION PROCESSING APPARATUS, OBJECT MANUFACTURING APPARATUS, AND MANUFACTURING METHOD FOR AN OBJECT

(71) Applicant: Sony Corporation, Tokyo (JP)

(72) Inventor: Masayuki Ohta, Tokyo (JP)

(73) Assignee: SONY CORPORATION, Tokyo (JP)

(21) Appl. No.: 13/657,410

(22) Filed: Oct. 22, 2012

(30) Foreign Application Priority Data
Oct. 28, 2011 (JP) 2011-236847

(51) Int. Cl. G06F 19/00

(52) U.S. Cl. 702/81

(57) ABSTRACT

An inspection apparatus includes a detector, a transmitter, and a receiver. The detector is configured to detect whether or not an object processed by a processing apparatus has a defect. The transmitter is configured to send defect information regarding the defect detected by the detector to the processing apparatus. The receiver is configured to receive, when the processing apparatus performs solving processing based on solving measure information corresponding to the defect information and sends content information regarding contents of the solving processing, the sent content information.

### BACKGROUND

The present disclosure relates to a processing apparatus that processes an object, an inspection apparatus that inspects the object, an information processing apparatus that is used in processing by those apparatuses, an object manufacturing apparatus that manufactures the object, and a manufacturing method for the object.

Japanese Patent Application Laid-open No. 2003-067027 (hereinafter, referred to as Patent Document 1) describes a quality information server being an information processing apparatus. This quality information server receives defect information regarding a product that is sent from a first terminal and analyzes the defect information based on product information stored on a storage device of the quality information server and the defect information sent from the first terminal. Then, according to the analyzing result, the quality information server selects, among a plurality of terminals, a second terminal to be notified of analyzing information including the analyzing result and sends the analyzing information to the selected second terminal. For example, each terminal is provided to each production section of a company. The quality information server sends the analyzing information of the defect information to a terminal placed in a production section being a responsible section associated with contents of the defect by an electronic mail (e.g., see paragraphs [01117] and [0118] and the like in specification of Patent Document 1).

As another technique, in a system including an electronic component mounting apparatus, the following technique has been proposed in related art, for example. Specifically, a component being a target to be mounted is mounted on a printed substrate and the substrate is inspected by an inspection device. Then, if a defect is detected, the inspection device sends information on the defect to a mounting apparatus. The mounting apparatus thereby performs a predetermined correction operation based on the information.

### SUMMARY

With such a technique, for example, when the inspection device detects a defect of the substrate, the mounting apparatus merely performs the predetermined correction operation based on information on the defect. However, in order to overcome the defect of the product or to increase production efficiency such as yield rate, further various improvements are necessary.

In view of the above-mentioned circumstances, there is a need for providing an inspection apparatus, a processing apparatus, an information processing apparatus, an object manufacturing apparatus, and a manufacturing method for an object, that are capable of increasing production efficiency.

According to an embodiment of the present disclosure, there is provided an inspection apparatus including a detector, a transmitter, and a receiver.

The detector is configured to detect whether or not an object processed by a processing apparatus has a defect.

The transmitter is configured to send defect information regarding the defect detected by the detector to the processing apparatus.

The receiver is configured to receive, when the processing apparatus performs solving processing based on solving measure information corresponding to the defect information and sends content information regarding contents of the solving processing, the sent content information.

In the embodiment of the present disclosure, the processing apparatus performs the solving processing based on the solving measure information corresponding to the defect information generated by the inspection apparatus, and the inspection apparatus obtains the content information regarding the contents of the solving processing by the processing apparatus. With this, for example, the inspection apparatus further inspects the object, to thereby be enabled to generate information indicating which solving processing can overcome the defect and what to extent. As a result, it is possible to increase production efficiency.

The receiver may be configured to receive, when the processing apparatus sends identification information for identifying the object processed by the processing apparatus after the solving processing, the sent identification information. With this, the inspection apparatus is enabled to identify the object before/after the solving processing.

The receiver may be configured to receive, when the processing apparatus sends identification information individually provided to the object, the identification information.

The receiver may be configured to receive, when the processing apparatus sends time information regarding a point of time of the solving processing by the processing apparatus as the identification information, the time information.

The processing apparatus may include a printing apparatus configured to print an electrically conductive portion on a substrate being the object, and the detector may be configured to detect a printing state of the electrically conductive portion on the substrate. With this, it is possible to solve a defect of the printing state of the electrically conductive portion.

For example, the printing apparatus may include a solder paste printing apparatus including a screen, and a squeegee configured to spread solder paste on the screen, to thereby transfer the solder paste on the substrate. In this case, the detector may be configured to detect whether or not the solder paste is transferred in a predetermined printing area on the substrate. Further, the transmitter may be configured to send one of a piece of information indicating that the solder paste is transferred beyond the predetermined printing area and a piece of information indicating that the solder paste transferred on the substrate fails to fill the predetermined printing area, as the defect information.

The processing apparatus may include a mounting apparatus configured to mount a component on a substrate being the object, and the detector may be configured to detect a mounting state of the component on the substrate. With this, it is possible to solve a defect of the mounting state of the component on the substrate.

For example, the detector may be configured to detect an offset of a mounting position of the component on the substrate, and the transmitter may be configured to send offset information regarding the offset of the mounting position of the component as the defect information.

According to another embodiment of the present disclosure, there is provided a processing apparatus including an object processor, a receiver, a solving processor, and a transmitter.

The object processor is configured to process an object.

The receiver is configured to receive, when the inspection apparatus inspects whether or not the object processed by the object processor has a defect and sends defect information regarding the detected defect, the sent defect information.

The solving processor is configured to perform solving processing based on solving measure information corresponding to the defect information.

The transmitter is configured to send content information regarding contents of the solving processing.

In the embodiment of the present disclosure, the processing apparatus performs the solving processing based on the solving measure information corresponding to the defect information generated by the inspection apparatus, and the inspection apparatus obtains the content information regarding the contents of the solving processing by the processing apparatus. With this, for example, the inspection apparatus further inspects the object, to thereby be enabled to generate the information indicating which solving processing can overcome the defect what to extent. As a result, it is possible to increase the production efficiency.

For example, the object processor may include a head configured to hold a component and mount the component on the substrate, and a movement mechanism configured to move the head and the substrate relative to each other. Further, the solving processor may be configured to correct, as a solving measure against the defect, one of a relative position between the head and the substrate by the movement mechanism upon mounting of the component and a holding position of the component in the head.

According to still another embodiment of the present disclosure, there is provided an information processing apparatus including a receiver and a transmitter.

The receiver is configured to receive, when an inspection apparatus inspects whether or not an object processed by a processing apparatus has a defect and sends defect information regarding the detected defect, the sent defect information. The receiver is further configured to receive, when the processing apparatus performs solving processing based on solving measure information corresponding to the defect information and sends content information regarding contents of the solving processing, the sent content information.

The transmitter is configured to send the received defect information to the processing apparatus and send the received content information to the inspection apparatus.

According to still another embodiment of the present disclosure, there is provided an object manufacturing apparatus including an inspection apparatus and a processing apparatus.

The inspection apparatus includes a detector configured to detect whether or not an object processed by a processing apparatus has a defect, and a transmitter configured to send defect information regarding the defect detected by the detector to the processing apparatus.

The processing apparatus includes an object processor configured to process the object, a receiver configured to receive the defect information sent from the inspection apparatus, a solving processor configured to perform solving processing based on solving measure information corresponding to the defect information, and a transmitter configured to send content information regarding contents of the solving processing to the inspection apparatus.

According to still another embodiment of the present disclosure, there is provided a manufacturing method for an object including processing the object by a processing apparatus.

An inspection apparatus inspects whether or not the object processed by the processing apparatus has a defect.

The inspection apparatus sends defect information regarding the detected defect to the processing apparatus.

The processing apparatus performs solving processing based on solving measure information corresponding to the defect information.

Content information regarding contents of the solving processing by the processing apparatus is sent to the inspection apparatus.

As described above, according to the embodiments of the present disclosure, it is possible to increase object production efficiency.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic view showing a substrate manufacturing apparatus (object manufacturing apparatus) according to a first embodiment of the present disclosure;

FIG. 2 is a flowchart showing operations of the substrate manufacturing apparatus;

FIGS. 3A to 3D are schematic views for explaining the operations;

FIGS. 4A to 4D are schematic views for explaining the operations;

FIGS. 5A and 5B are schematic views for explaining the operations;

FIG. 6 is a view showing contents of information stored by a solder paste printing apparatus;

FIG. 7 is a schematic view showing a substrate manufacturing apparatus according to a second embodiment of the present disclosure; and

FIG. 8 is a schematic view showing a substrate manufacturing apparatus including a processing apparatus and an inspection apparatus that communicate with each other via a server.

### DETAILED DESCRIPTION OF EMBODIMENTS

Hereinafter, embodiments of the present disclosure will be described with reference to the drawings.

### First Embodiment

(Configuration of Substrate Manufacturing Apparatus)

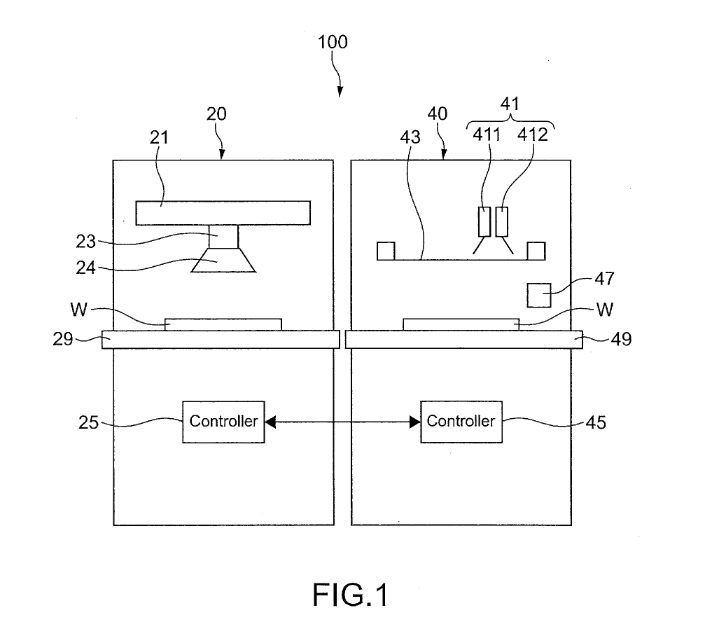

FIG. 1 is a schematic view showing a substrate manufacturing apparatus (object manufacturing apparatus) according to a first embodiment of the present disclosure. The substrate manufacturing apparatus 100 includes a solder paste printing apparatus 40 and an inspection apparatus 20. The solder paste printing apparatus 40 serves as a processing apparatus that processes a substrate (printed substrate) W being an object. The inspection apparatus 20 is provided on a downstream side of the solder paste printing apparatus 40 to inspect the substrate W processed by the solder paste printing apparatus 40.

<Configuration of Solder Paste Printing Apparatus>

The solder paste printing apparatus 40 includes a pair of squeegees 41, a screen 43, a conveyor unit 49, a cleaning unit 47, and a controller 45.

The pair of squeegees 41 are moved on the screen 43 by a movement mechanism (not shown), to thereby spread solder paste on the screen 43, the solder paste being supplied on the screen 43 by a user or an automatic supply unit (not shown). With this, through openings in predetermined-shaped solder patterns that are formed in the screen 43, the solder paste in such patterns is transferred on the substrate W.

The pair of squeegees 41 are both configured to be movable in upper and lower directions. For example, a squeegee 412 on a right-hand side in the figure downwardly moves, and the pair of squeegees 41 integrally move to a left-hand side while the squeegee 412 is spreading the solder paste. Further, a squeegee 411 on the left-hand side downwardly moves, and the pair of squeegees 41 integrally move to the right-hand side while the squeegee 411 is spreading the solder paste. In this manner, the two squeegees 411 and 412 are alternately used in reciprocating operations. It should be noted that only one squeegee may be provided.

As described above, the screen 43 (e.g., metal screen) has the openings in the predetermined-shaped patterns and the solder paste is transferred on the substrate W through the openings. With this, the solder patterns arranged in the predetermined shape are formed as an electrically conductive portion on the substrate W.

The pair of squeegees 41 and the screen 43 function as an object processor that processes the object.

The conveyor unit 49 conveys the substrate W from the right to the left in the figure and unloads, on the left-hand side, the substrate W to the conveyor unit 49 of the inspection apparatus 20, which will be described later. The conveyor unit 49 includes a clump mechanism (not shown). When the substrate W is printed, the substrate W is placed between the clump mechanism and the screen 43 and clumped so that positioning of the substrate W is performed.

The cleaning unit 47 is provided below the screen 43, for example. The cleaning unit 47 includes a contact member to be brought into contact with a lower portion of the screen 43, such as a brush and a squeegee. The cleaning unit 47 cleans the screen 43 while moving in right- and left-hand directions with the contact member being held in contact with the lower portion. The cleaning unit 47 performs cleaning by at least one of a dry method and a wet method. In the case of the wet method, the cleaning unit 47 supplies the screen 43 with a solvent for the cleaning.

The controller 45 controls driving of the pair of squeegees 41, the screen 43, the conveyor unit 49, the cleaning unit 47, and the others (not shown). The controller 45 has basic computer functions, for example, a CPU (central processing unit), a ROM (read only memory), and a RAM (random access memory), which are not shown. Further, the controller 45 also includes a communication unit (receiver and transmitter) that communicates with a controller 25 of the inspection apparatus 20. The controller 45 may further include another storage device.

Further, the controller 45 stores solving measure information for solving a defect, which corresponds to defect information regarding a defect of a printing state, using a lookup table, for example. As will be described later, when the inspection apparatus 20 inspects the printing state of the substrate W printed by the solder paste printing apparatus 40 and a defect of the printing state is detected, the controller 45 obtains defect information thereof.

<Configuration of Inspection Apparatus>

The inspection apparatus 20 includes an XY robot 21, a camera 23, a lighting device 24, a conveyor unit 29, and a controller 25.

The XY robot 21 is provided above the camera 23 and the lighting device 24 to move the camera 23 and the lighting device 24 substantially along two-axial directions orthogonal to each other in a horizontal plane. With this, the printing state of an arbitrary area on a surface of the substrate W is inspected.

The camera 23 includes a CCD (charge coupled device) or a CMOS (complementary metal-oxide semiconductor) device and is connected to the XY robot 21. The camera 23 is moved by the XY robot 21 to an arbitrary position on the substrate W and images a predetermined area on the substrate W.

The lighting device 24 is fixed to the camera 23 to move integrally with the camera 23. The lighting device 24 is formed in a ring shape having a hole in a center thereof. Through the hole, the camera 23 images the substrate W.

The conveyor unit 29 conveys the substrate W loaded from the conveyor unit 29 of the solder paste printing apparatus 40 to the left direction in the figure. The conveyor unit 29 includes a clump mechanism (not shown). When the printing state is inspected, this clump mechanism clumps the substrate W so that positioning of the substrate W is performed.

The controller 25 controls driving of the XY robot 21, the camera 23, the lighting device 24, the conveyor unit 29, and the others (not shown). The controller 25 has computer functions similar to the controller 45 of the solder paste printing apparatus 40 and also includes a communication unit (receiver and transmitter) that communicates with the controller 45. Further, the controller 25 includes software for analyzing an image imaged by the camera 23 to detect a defect of the printing state. The controller 25 may perform such an image analysis by any known methods.

The camera 23 and the controller 25 function as a detector that detects a defect of the printing state.

Although the configurations of the solder paste printing apparatus 40 and the inspection apparatus 20 have been described above, the present disclosure is not limited to the above-mentioned configurations. Any known configurations of the solder paste printing apparatus and the inspection apparatus may be employed in the present disclosure.

(Operations of Substrate Manufacturing Apparatus)

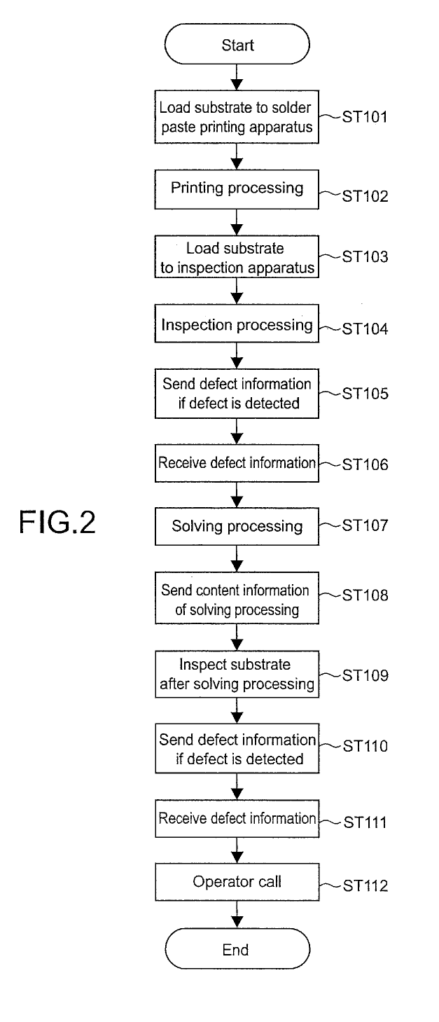

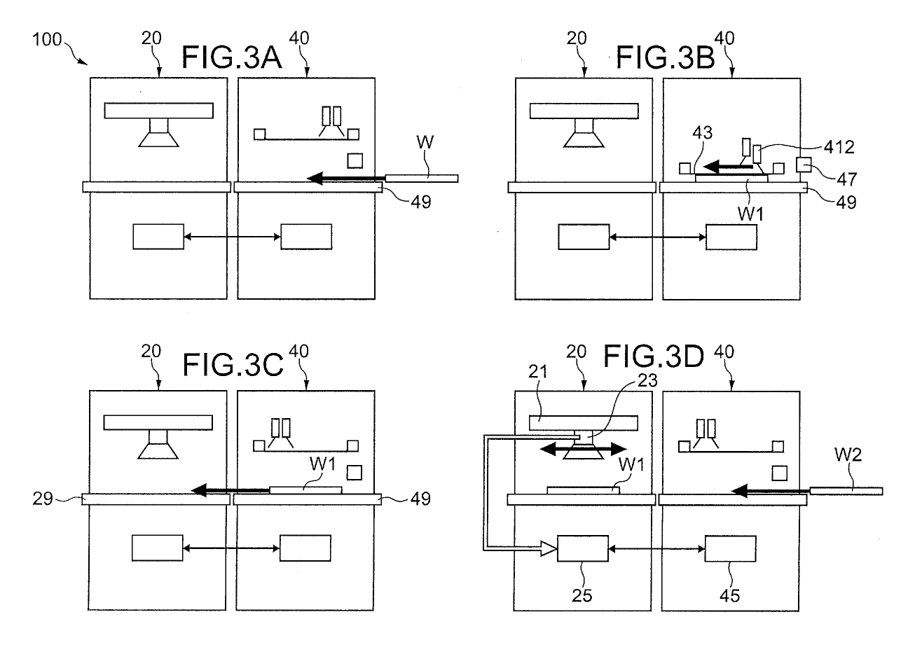

Operations of the thus configured substrate manufacturing apparatus 100 will be described. FIG. 2 is a flowchart showing the operations. FIGS. 3A to 5B are schematic views for explaining the operations.

As shown in FIG. 3A, a substrate W1 is loaded by the conveyor unit 49 to the solder paste printing apparatus 40 (Step 101) and positioned at a predetermined position. As shown in FIG. 3B, with the positioned substrate W1, the pair of squeegees 41 and the screen 43 integrally move downwards so that the screen 43 is brought into close contact with the substrate W1, and solder paste is printed in a predetermined pattern on the substrate W1 (Step 102). After the printing processing, as shown in FIG. 3C, the conveyor unit 49 unloads the substrate W1 and the conveyor unit 29 of the inspection apparatus 20 loads the substrate W1 (Step 103). Further, as shown in FIG. 3D, at a timing at which the substrate W1 is loaded to the inspection apparatus 20 or after this timing, another substrate W2 is loaded to the solder paste printing apparatus 40 as in Step 101. Then, in the inspection apparatus 20, a printing state of the substrate W1 is inspected (Step 104), and solder paste is printed on the loaded substrate W2 as in Step 102.

In the inspection apparatus 20, while the XY robot 21 is moving the camera 23, the camera 23 images a predetermined area. For example, an edge of the area in which the solder paste is transferred (boundary between solder-printed area and solder-unprinted area) is imaged. The controller 25 analyzes the image.

As one example of an analysis method therefor, the following method is assumed. For example, the controller 25 compares position information on a land on the substrate W1 that is stored in advance with position information on the edge of the solder paste. Based on whether or not the position of the edge of the solder paste is transferred within a predetermined error range with respect to the position of the land, whether or not any defect is present is determined.

Alternatively, the controller 25 may perform determination processing in accordance with a difference of an optical reflectance (color) in the position of the land.

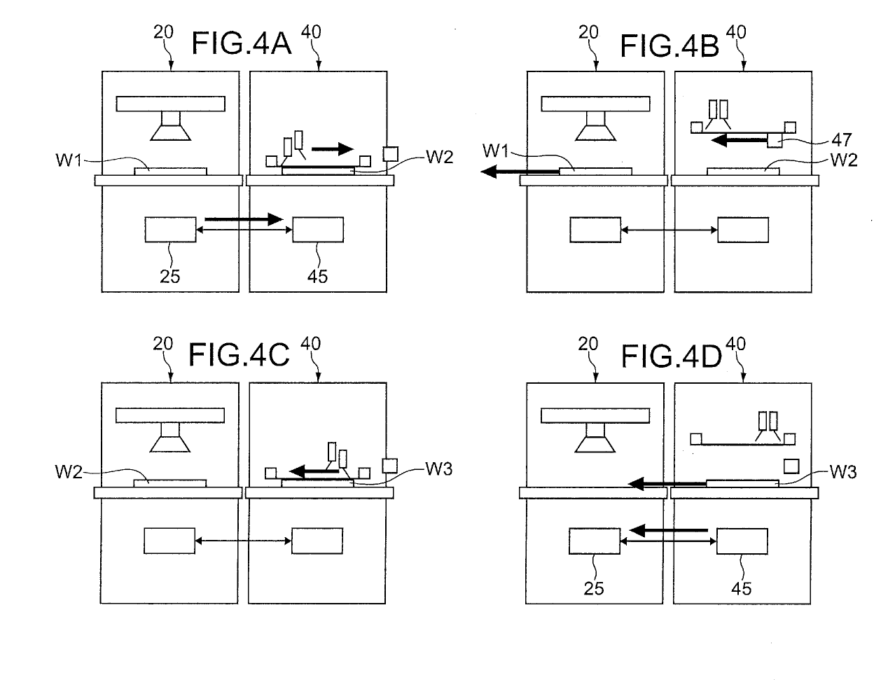

When detecting a defect, the controller 25 sends defect information to the controller of the solder paste printing apparatus 40 as shown in FIG. 4A (Step 105), the defect information including information on a defect mode and a defect generation area.

The information on the defect mode means information on the position of the edge of the solder paste, that is, information indicating that the area in which the solder paste is transferred beyond the land area (excess paste) or that the predetermined area in the land is not filled with the solder paste (insufficient paste), for example. Herein, “insufficient paste” includes “lack of paste” where any solder paste is not transferred in the predetermined area of the land in which the solder paste is to be transferred.

The defect generation area means a partial area of the entire area of the substrate W imaged by the camera 23 (area within imaging range).

Alternatively, as the defect of the printing state, when an offset between the land area and the solder paste transferred area occurs, the defect information may include information on an amount of offset.

As described above, the controller 25 sends the information on the defect mode, the defect generation area, the amount of offset, and the like to the controller 45 of the solder paste printing apparatus 40.

The defect information sent from the controller 25 of the inspection apparatus 20 is received by the controller 45 of the solder paste printing apparatus 40 (Step 106). Here, if the controller 45 is performing the printing processing on the substrate W2 when the controller 45 receives the defect information, the controller 45 continues performing the printing processing on the substrate W2 and interrupts loading of the subsequent substrate W. That is, until the controller 45 receives the defect information, the solder paste printing apparatus 40 continues performing processing on the substrate W (W2) different from the substrate W (W1), in which the defect occurs, under the same condition as that of the substrate W (W1) in which the defect occurs.

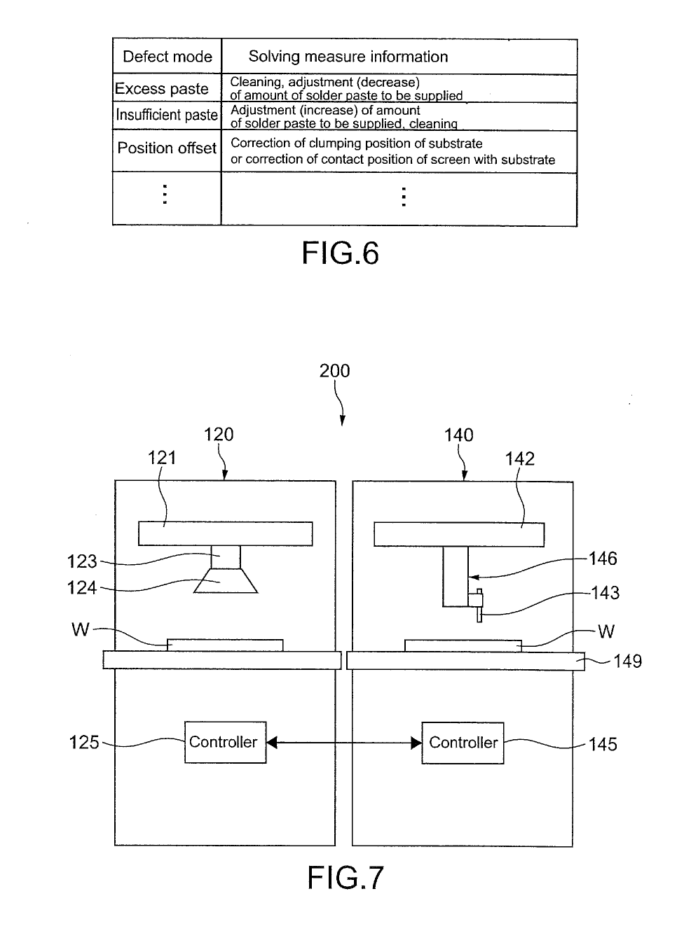

As described above, the controller 45 extracts solving measure information corresponding to the received defect information (in particular, defect mode) from its storage area and performs solving processing corresponding to this solving measure (Step 107). For example, according to the lookup table as shown in FIG. 6, the controller 45 stores the defect mode and the solving measure information corresponding thereto on the storage area and specifies the solving measure information corresponding to the defect mode.

The solving measure information corresponding to the defect mode of “excess paste” is, for example, information for performing cleaning by the cleaning unit 47. In the case where the screen 43 is not clean, “excess paste” in the printing occurs. In this case, the solder paste printing apparatus 40 can remove extra solder paste adhering to the screen 43 by cleaning the screen 43 as the solving processing as shown in FIG. 4B. In this case, at least the cleaning unit 47 functions as the solving processor.

As another solving measure against “excess paste,” in the case where the solder paste is supplied by the automatic supply unit onto the screen 43, adjustment to reduce the amount of solder paste to be supplied onto the screen 43 may be performed. In this case, at least the automatic supply unit functions as the solving processor.

On the other hand, for example, in the case where the amount of solder paste to be supplied is less than a predetermined amount or the screen 43 is not clean, “insufficient paste” occurs. In this case, the solder paste printing apparatus 40 performs adjustment to increase the amount of solder paste to be supplied or cleans the screen 43 by the cleaning unit 47 as the solving processing.

Otherwise, in the case where a position offset occurs as the defect mode, as shown in FIG. 6, as the solving measure against it, correction of the clumping position of the substrate W by the conveyor unit 49 or correction of the contact position of the screen 43 with the substrate W is performed. In this case, at least one of the clump mechanism of the conveyor unit 49 and the movement mechanism for the screen 43 functions as the solving processor.

Further, as the solving processing, there are adjustment of a pressing force of the squeegee 41 to the screen 43, adjustment of moving speed of the squeegee 41, and the like.

When the solder paste printing apparatus 40 performs the solving processing, as shown in FIG. 4C, the solder paste printing apparatus 40 performs, on a substrate W3 next to be loaded, solder paste printing processing under a condition after the solving processing.

As shown in FIG. 4D, before the start of printing processing after the solving processing, in the middle of the printing processing, or after the completion of the printing processing, the controller 45 sends content information regarding the contents of the solving processing to the controller 25 of the inspection apparatus 20 (Step 108).

In the case where the solving measure is the cleaning processing by the cleaning unit 47, the content information regarding the contents of the solving processing means information on, for example, the number of times of cleaning, whether the cleaning processing method is dry method or wet method, and a cleaning position (on screen 43). Otherwise, in the case where the solving measure is the adjustment of the amount of solder paste to be supplied, the content information regarding the contents of the solving processing means information on an amount of increase or decrease thereof. Otherwise, in the case where the solving measure is the correction of the clumping position of the substrate W or the correction of the contact position of the screen 43 with the substrate W, the content information regarding the contents of the solving processing means information on an amount of correction thereof.

Alternatively, the controller 45 may also send time information regarding a point of time of the solving processing as the content information regarding the contents of the solving processing (at the start, in the middle, or at the end of solving processing) to the controller 25 of the inspection apparatus 20.

Further, the controller may also send identification information of the substrate W printed under the condition after the solving processing to the controller of the inspection apparatus 20.

Herein, the identification information of the substrate W is the identification information (ID) individually provided to the substrate W. For example, the identification information of the substrate W is a bar code provided to the substrate W or a chip storing the identification information that is attached to the substrate W. In this case, the solder paste printing apparatus 40 only needs to use an optical sensor (not shown), the camera 23, a reader for chip information, or the like, that is provided in the apparatus 40 to read and store the ID of the substrate W.

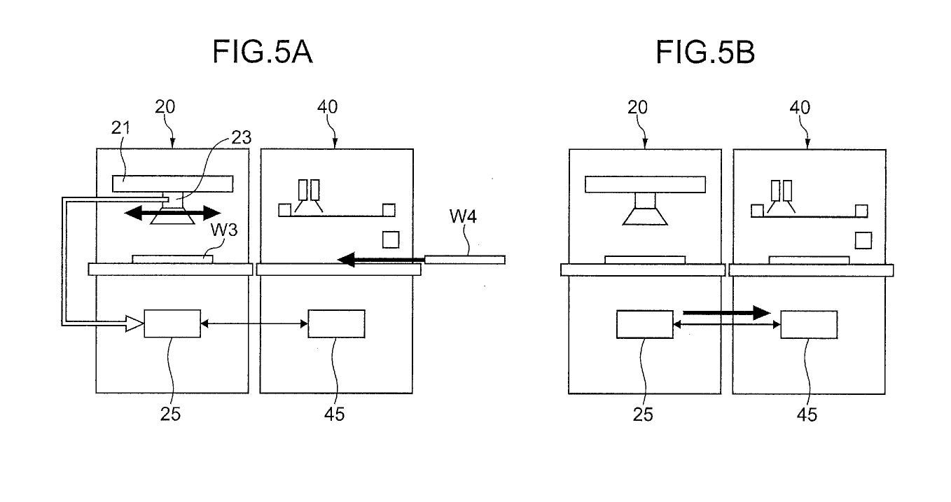

As shown in FIG. 5A, the substrate W printed under the condition after the solving processing is loaded to the inspection apparatus 20 and the same inspection as that described above is performed thereon (Step 109). Here, as shown in FIG. 5B, if any defect is detected again, the controller 25 sends defect information thereof to the controller 45 of the solder paste printing apparatus 40 (Step 110). The controller 45 receives this defect information (Step 111), and then performs predetermined processing such as an operator call (Step 112). In this case, the controller 45 of the solder paste printing apparatus 40 stops driving of the solder paste printing apparatus 40. Of course, when, in Step 109, it is determined as the inspection result that the printing state is not abnormal, the substrate manufacturing apparatus 100 continues performing processing on the substrate W under the current condition.

Since the printed substrate W has been developed to increase the density and reduce the size in recent years, it has been very difficult to manage processes thereof. In particular, due to influence of dust caught by the substrate W itself, the printing condition more severe than that in the past, and the like, defects are easier to occur than before. Therefore, when a defect in a product is detected by the inspection apparatus 20, for example, a worker (user) immediately stops the apparatus in order to overcome the defect at early stage.

However, in this embodiment, the inspection apparatus 20 detects the defect information and the solder paste printing apparatus 40 obtains the defect information in order to perform the solving processing. That is, when the defect information is input into the solder paste printing apparatus 40, the apparatus 40 is not immediately stopped but performs the solving processing. With this, it is possible to reduce the number of times of stopping the solder paste printing apparatus 40, and hence to increase production efficiency. In addition, the solder paste printing apparatus 40 sends the content information regarding the contents of the solving processing to the inspection apparatus 20 and the inspection apparatus 20 performs inspection again, so that the worker can extracts, from the controller 25 of the inspection apparatus 20, information indicating which solving processing can overcome the defect and to what extent. With this, it is possible to increase yield rate, and hence, the production efficiency.

In the case where, in Step 108, the controller 45 of the solder paste printing apparatus 40 also outputs the identification information of the substrate W printed under the condition after the solving processing, the controller 25 of the inspection apparatus 20 is enabled to identify the substrate W after/before the solving processing. As a result, the inspection apparatus 20 is enabled to automatically learn which solving processing can overcome the defect and to what extent. In particular, as described above, until the controller 45 receives the defect information, the solder paste printing apparatus 40 continues performing processing on the substrate W different from the substrate in which the defect has occurred (substrate W may include a plurality of substrates W), under the same condition as that of the substrate W in which the defect has occurred. Also in such a case, if the identification information of the substrate W is sent to the inspection apparatus 20, the inspection apparatus 20 is enabled to correctly identify the substrate W before/after the solving processing.

Upon unloading of the substrate W from the solder paste printing apparatus 40, information indicating by which of the squeegees 411 and 412 of the pair of squeegees 41 the substrate W is processed may be sent by the controller to the controller of the inspection apparatus 20. Information indicating which processing by the squeegee 411 or 412 results in an incorrect printing position of the substrate W when the inspection apparatus 20 performs position offset inspection may be included in the defect information in the position offset inspection. In this case, it is not limited to the position offset inspection and also applicable to the amount of solder paste.

Here, irrespective of whether or not a defect occurs in the printing state of the substrate W, the following information may be generated. When the automatic supply unit supplies the solder paste, in the case where the inspection apparatus 20 does not detect any defects of the printing state (particularly, amount of solder paste) and, for example, the amount of solder transferred is equal to or less than a predetermined amount, the inspection apparatus 20 may send, to the solder paste printing apparatus 40, information on this. That is, the defect information is not sent but the information indicating that the amount of solder paste is equal to or less than the predetermined amount is sent. Then, when the solder paste printing apparatus 40 receives this information, the automatic supply unit only needs to additionally supply solder paste.

For example, in the case where the defect information regarding the defect detected by the inspection apparatus 20 exceeds a management limit and does not exceed a defect limit, the defect information may be stored and the defect information does not need to be sent to the solder paste printing apparatus 40.

In the case where the kind of the substrate W is a paper phenol substrate or the like that has low manufacturing accuracy, there is a fear that the paper phenol substrate may shrink due to, for example, influence of humidity in environments where the substrate manufacturing apparatus 100 is placed. In this case, it is difficult to print solder paste at correct positions on the substrate W in entire surface thereof.

In this case, an area in which the highest printing accuracy is necessary in the entire surface of the substrate W is set in advance. Information on a correction value (offset value) enabling the inspection apparatus 20 to print solder paste in such an area at the highest accuracy is generated and sent to the solder paste printing apparatus 40 as the defect information. The solder paste printing apparatus 40 receives this information and performs the solving processing according to the correction value as described above. Then, the paper phenol substrate printed after this solving processing is inspected by the inspection apparatus 20 again. Thus, the controller of the inspection apparatus 20 is enabled to calculate a correction coefficient of a subsequent substrate.

Further, in this case, even if, as a result of re-inspection of a printing state of an area in which relatively low printing accuracy is only necessary, a defect is detected in the printing state, the inspection apparatus 20 may be set not to send defect information thereof to the solder paste printing apparatus 40. That is, the inspection apparatus 20 may change the inspection condition (criterion to determine whether or not to generate defect information) depending on the areas having different printing accuracy in the surface of the substrate W. With this, the yield rate of a product, and hence, the production efficiency are increased.

### Second Embodiment

FIG. 7 is a schematic view showing a substrate manufacturing apparatus according to a second embodiment of the present disclosure. In the following, descriptions of the same constituent elements, functions, and the like as those of the substrate manufacturing apparatus 100 according to the embodiment shown in FIG. 1 and the like will be simplified or omitted and different point(s) will be mainly described.

A substrate manufacturing apparatus 200 includes a mounting apparatus 140 and an inspection apparatus 120. The mounting apparatus 140 mounts a component on a substrate W. The inspection apparatus 120 is provided on a downstream side of the mounting apparatus 140 to inspect a mounting state of the component on the substrate W processed by the mounting apparatus 140.

The mounting apparatus 140 includes an XY robot 142 (movement mechanism), a mounting head 146, a conveyor unit 149, and a controller 125. The XY robot 142 moves the mounting head 146 along two-axial directions orthogonal to each other. The mounting head 146 includes a nozzle 143 capable of holding components such as a resistor and a capacitor. Further, the nozzle 143 is movable in upper and lower directions. The nozzle 143 holds a component by, for example, vacuum suction. Further, the mounting apparatus 140 includes, although not shown, a tape feeder housing therein the components. The mounting head 146 picks up a component from the tape feeder and mounts the picked up component on the substrate W positioned by the conveyor unit 149 and clumped.

The inspection apparatus 120 includes, as in the first embodiment, constituent elements such as an XY robot 121, a camera 123, and a lighting device 124. The controller 125 of the inspection apparatus 120 analyzes an image of a predetermined mounting area on the substrate W that is imaged by the camera 123 and detects defects of mounting states of components mounted on the substrate W by the mounting apparatus 140. A plurality of cameras 23 may be used.

The defect of the mounting state means, for example, an offset of a mounting position of the component (horizontal offset or rotational offset in surface of substrate W, tilt on substrate W, or the like).

Although the configurations of the mounting apparatus 140 and the inspection apparatus 120 have been described, the present disclosure is not limited to the above-mentioned configurations. Any known configurations of the mounting apparatus and the inspection apparatus may be employed in the present disclosure.

The controller of the inspection apparatus 120 according to this embodiment generates the defect information and sends the defect information to the controller 145 of the mounting apparatus 140 and the controller 145 receives the defect information as in the first embodiment. The controller 145 retains information on a solving measure corresponding to the defect information and performs the solving processing based on this information.

Examples of the solving measure include correction of a relative position between the mounting head 146 and the substrate W by the XY robot 142 upon mounting of the component on the substrate W and correction of a holding position of the component by the nozzle 143 of the mounting head 146. As the solving processing, the mounting apparatus 140 only needs to determine an amount of correction thereof based on the defect information and correct the position.

Also in this embodiment, when the inspection apparatus 120 detects a defect and sends defect information thereof and the controller 145 of the mounting apparatus 140 obtains the defect information, the controller 145 does not immediately stop driving of the apparatus 140 but performs solving processing against it. Therefore, it is possible to reduce the number of times of stopping the mounting apparatus 140, and hence to increase the production efficiency. Further, the inspection apparatus 120 obtains content information regarding the contents of the solving processing by the mounting apparatus 140 and performs inspection again, so that the worker can extract, from the controller 125, information indicating which solving processing can overcome the defect and to what extent. With this, it is possible to increase the yield rate, and hence, the production efficiency.

Further, also in this embodiment, the mounting apparatus 140 sends, to the inspection apparatus 120, the identification information of the substrate W to be a target to be processed after the solving processing, so that the inspection apparatus 120 can correctly identify the substrate W before/after the solving processing.

For example, in the mounting apparatus 140, a case where the worker adds a tape feeder, that is, components will be described. In the case where the addition of the components is necessary, the mounting apparatus 140 presents, to the worker via a screen or the like, information on a code of the components, that is, component identification information for identifying the kind of the components. After the presentation, the worker installs the tape feeder filled with the components into the mounting apparatus 140. In this case, no problems are caused if the component identification information corresponds to component identification information regarding the components housed in the tape feeder actually added. However, if they do not correspond to each other, there is a fear that the mounting apparatus 140 may mount a component different from a component expected to be mounted (component with component identification information presented to worker via screen or the like) on the substrate W.

In order to solve such a problem, the mounting apparatus 140 only needs to store the component identification information regarding components requested by the mounting apparatus 140 itself to be added and the identification information of the substrate W to be a target to be mounted after the addition with these pieces of information corresponding to each other, and then to send such information to the inspection apparatus 120. In this case, the inspection apparatus 120 inspects whether or not the component with the component identification information is mounted on the substrate W with the identification information. This inspection is typically performed using image processing.

This inspection checks whether or not correct component addition is performed. When a component different from a desired component is mounted, the inspection apparatus 120 detects this error and sends error information thereof to the mounting apparatus 140. With this, the inspection apparatus 120 or the mounting apparatus 140 can perform an operator call.

### Third Embodiment

A substrate manufacturing apparatus according to a third embodiment of the present disclosure includes, although not shown, the following apparatuses. For example, the substrate manufacturing apparatus includes a first inspection apparatus, a reflow apparatus, and a second inspection apparatus. The first inspection apparatus performs inspection after the solder paste printing processing. The reflow apparatus is provided on a downstream side of the first inspection apparatus. The second inspection apparatus is provided on a downstream side of the reflow apparatus.

A controller of the first inspection apparatus has a first criterion for determining that a defect of a printing state thereof occurs and a second criterion being a fixed criterion for determining that no defects of the printing state occur. Those first and second criteria are typically set by software. For example, the first criterion may be based on the fact that, in a predetermined area of the substrate, for example, solder paste is transferred beyond the edge of a land. The second criterion may be based on the fact that solder paste is transferred at a position between a position deviated by a first distance from the edge of a land to the center of the land and the edge of the land. Those criteria may be appropriately changed.

The controller of the first inspection apparatus determines that the second criterion is not satisfied and sends identification information of the substrate W, to which such a determination is made, area information regarding an area of the substrate, which does not satisfy the second criterion, and determination information regarding the determination, to a controller of the second inspection apparatus. When inspecting the substrate W with the identification information after reflow processing, the second inspection apparatus 20 thoroughly inspects, in particular, the area indicated by the received area information. The thorough inspection means, for example, increasing inspection times and inspection accuracy (number of criteria).

The second inspection apparatus sends inspection result information regarding the inspection result by the second inspection apparatus to the first inspection apparatus. The first inspection apparatus collects pieces of inspection result information thereof, and changes a value of the second criterion (or the first criterion) if the second criterion (or the first criterion) is too severe, in order to avoid misinformation.

The technique according to this embodiment has been made considering a case where even a substrate not satisfying a certain criterion before reflow may satisfy this criterion after the reflow.

### Other Embodiments

The present disclosure is not limited to the above-mentioned embodiments and various other embodiments can be realized.

As the above-mentioned printing apparatus, the solder paste printing apparatus 40 is exemplified. The present disclosure is applicable even to an apparatus other than the solder paste printing apparatus 40 as long as the apparatus is a printing apparatus that prints a wiring pattern as the electrically conductive portion on the substrate W.

As the identification information of the substrate W, the identification information for individually identifying the substrate W is exemplified. However, the time information regarding a point of time of the solving processing by the processing apparatus such as the solder paste printing apparatus 40 (at the start, in the middle, or at the end) may be sent to the inspection apparatus as the identification information for identifying the substrate. If the inspection apparatus and the processing apparatus include clocks synchronized to each other even in the case where the inspection apparatus is incapable of individually identifying the substrate, the inspection apparatus can identify the substrate before/after the solving processing by obtaining the time information regarding a point of time of the solving processing.

Alternatively, as the identification information for identifying the substrate, number information regarding the number of processed substrates may be used after the inspection apparatus sends the defect information and the processing apparatus receives the defect information before the processing apparatus performs the solving processing. The processing apparatus sends the number information and the inspection apparatus receives the number information, so that it is possible to identify the substrate before/after the solving processing.

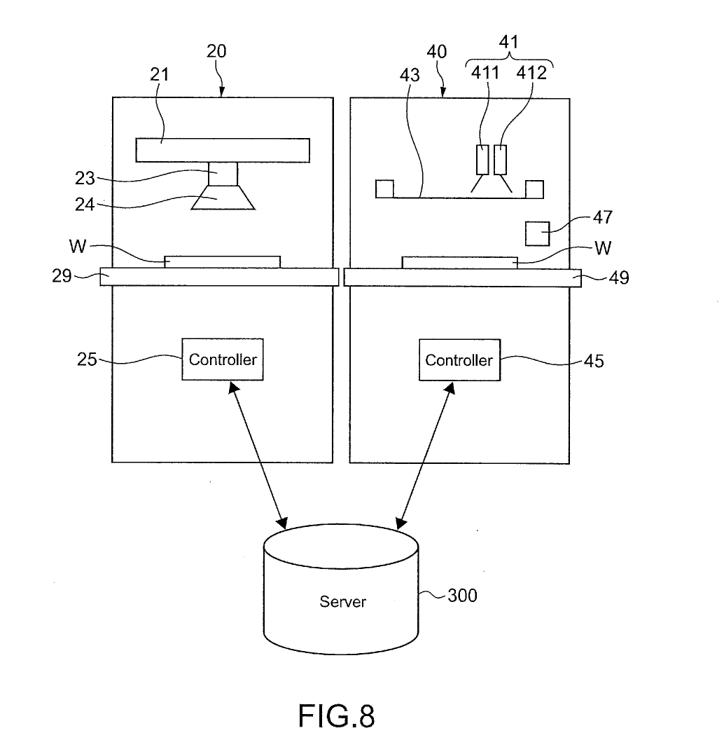

In the above-mentioned embodiments, the controllers of the processing apparatus and the inspection apparatus directly communicate with each other. However, as shown in FIG. 8, the controllers may communicate with each other via a server (information processing apparatus) 300 having computer functions. In this case, the information processing apparatus may store the lookup table as shown in FIG. 6 or may include a database indicating which solving processing by the processing apparatus overcomes the defect and to what extent.

At least two features of the features in each embodiment described above may be combined with each other.

The present disclosure may also be configured as follows.

(1) An inspection apparatus, including:

a detector configured to detect whether or not an object processed by a processing apparatus has a defect;

a transmitter configured to send defect information regarding the defect detected by the detector to the processing apparatus; and

a receiver configured to receive, when the processing apparatus performs solving processing based on solving measure information corresponding to the defect information and sends content information regarding contents of the solving processing, the sent content information.

(2) The inspection apparatus according to (1), in which

the receiver is configured to receive, when the processing apparatus sends identification information for identifying the object processed by the processing apparatus after the solving processing, the sent identification information.

(3) The inspection apparatus according to (2), in which

the receiver is configured to receive, when the processing apparatus sends identification information individually provided to the object, the identification information.

(4) The inspection apparatus according to (2), in which

the receiver is configured to receive, when the processing apparatus sends time information regarding a point of time of the solving processing by the processing apparatus as the identification information, the time information.

(5) The inspection apparatus according to any one of (1) to (4), in which

the processing apparatus includes a printing apparatus configured to print an electrically conductive portion on a substrate being the object, and

the detector is configured to detect a printing state of the electrically conductive portion on the substrate.

(6) The inspection apparatus according to (5), in which

the printing apparatus includes solder paste printing apparatus including
a screen, and
a squeegee configured to spread solder paste on the screen, to thereby transfer the solder paste on the substrate,

the detector is configured to detect whether or not the solder paste is transferred in a predetermined printing area on the substrate, and

the transmitter is configured to send one of a piece of information indicating that the solder paste is transferred beyond the predetermined printing area and a piece of information indicating that the solder paste transferred on the substrate fails to fill the predetermined printing area, as the defect information.

(7) The inspection apparatus according to any one of (1) to (4), in which

the processing apparatus includes a mounting apparatus configured to mount a component on a substrate being the object, and

the detector is configured to detect a mounting state of the component on the substrate.

(8) The inspection apparatus according to (7), in which

the detector is configured to detect an offset of a mounting position of the component on the substrate, and

the transmitter is configured to send offset information regarding the offset of the mounting position of the component as the defect information.

(9) A processing apparatus, including:

an object processor configured to process an object;

a receiver configured to receive, when the inspection apparatus inspects whether or not the object processed by the object processor has a defect and sends defect information regarding the detected defect, the sent defect information;

a solving processor configured to perform solving processing based on solving measure information corresponding to the defect information; and

a transmitter configured to send content information regarding contents of the solving processing.

(10) The processing apparatus according to (9), in which

the transmitter is configured to send identification information for identifying the object processed by the processing apparatus after the solving processing.

(11) The processing apparatus according to (9) or (10), in which

the object processor is configured to print an electrically conductive portion on a substrate being the object, and

the inspection apparatus is configured to inspect a printing state of the electrically conductive portion on the substrate and send a defect of the printing state as the defect information.

(12) The processing apparatus according to (11), in which

the object processor includes
a screen, and
a squeegee configured to spread solder paste on the screen, to thereby transfer the solder paste on the substrate, and

the solving processor is configured to perform, as a solving measure corresponding to the defect information, at least one type of solving processing of cleaning of the screen, adjustment of an amount of the solder paste to be supplied to the screen, and correction of a position offset of the substrate.

(13) The processing apparatus according to (9) or (10), in which

the object processor is configured to mount a component on a substrate being the object, and

the inspection apparatus is configured to inspect a mounting state of the component on the substrate and send a defect of the mounting state as the defect information.

(14) The processing apparatus according to (13), in which

the object processor includes
a head configured to hold a component and mount the component on the substrate, and
a movement mechanism configured to move the head and the substrate relative to each other, and

the solving processor is configured to correct, as a solving measure against the defect, one of a relative position between the head and the substrate by the movement mechanism upon mounting of the component and a holding position of the component in the head.

(15) An information processing apparatus, including:

a receiver configured to receive, when an inspection apparatus inspects whether or not an object processed by a processing apparatus has a defect and sends defect information regarding the detected defect, the sent defect information, and to receive, when the processing apparatus performs solving processing based on solving measure information corresponding to the defect information and sends content information regarding contents of the solving processing, the sent content information; and

a transmitter configured to send the received defect information to the processing apparatus and send the received content information to the inspection apparatus.

(16) An object manufacturing apparatus, including:

an inspection apparatus; and

a processing apparatus, the inspection apparatus including
a detector configured to detect whether or not an object processed by a processing apparatus has a defect, and
a transmitter configured to send defect information regarding the defect detected by the detector to the processing apparatus, the processing apparatus including
an object processor configured to process the object,
a receiver configured to receive the defect information sent from the inspection apparatus,
a solving processor configured to perform solving processing based on solving measure information corresponding to the defect information, and
a transmitter configured to send content information regarding contents of the solving processing to the inspection apparatus.
   (17) A manufacturing method for an object, including:

processing the object by a processing apparatus;

inspecting, by an inspection apparatus, whether or not the object processed by the processing apparatus has a defect;

sending, by the inspection apparatus, defect information regarding the detected defect to the processing apparatus;

performing, by the processing apparatus, solving processing based on solving measure information corresponding to the defect information; and

sending content information regarding contents of the solving processing by the processing apparatus to the inspection apparatus.

The present disclosure contains subject matter related to that disclosed in Japanese Priority Patent Application JP 2011-236847 filed in the Japan Patent Office on Oct. 29, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An inspection apparatus, comprising:
a detector configured to detect whether or not an object processed by a processing apparatus has a defect;
a transmitter configured to send defect information regarding the defect detected by the detector to the processing apparatus; and
a receiver configured to receive, when the processing apparatus performs solving processing based on solving measure information corresponding to the defect information and sends content information regarding contents of the solving processing, the sent content information.

2. The inspection apparatus according to claim 1, wherein
the receiver is configured to receive, when the processing apparatus sends identification information for identifying the object processed by the processing apparatus after the solving processing, the sent identification information.

3. The inspection apparatus according to claim 2, wherein
the receiver is configured to receive, when the processing apparatus sends identification information individually provided to the object, the identification information.

4. The inspection apparatus according to claim 2, wherein
the receiver is configured to receive, when the processing apparatus sends time information regarding a point of time of the solving processing by the processing apparatus as the identification information, the time information.

5. The inspection apparatus according to claim 1, wherein
the processing apparatus includes a printing apparatus configured to print an electrically conductive portion on a substrate being the object, and
the detector is configured to detect a printing state of the electrically conductive portion on the substrate.

6. The inspection apparatus according to claim 5, wherein
the printing apparatus includes a solder paste printing apparatus including
a screen, and
a squeegee configured to spread solder paste on the screen, to thereby transfer the solder paste on the substrate,
the detector is configured to detect whether or not the solder paste is transferred in a predetermined printing area on the substrate, and
the transmitter is configured to send one of a piece of information indicating that the solder paste is transferred beyond the predetermined printing area and a piece of information indicating that the solder paste transferred on the substrate fails to fill the predetermined printing area, as the defect information.

7. The inspection apparatus according to claim 1, wherein
the processing apparatus includes a mounting apparatus configured to mount a component on a substrate being the object, and
the detector is configured to detect a mounting state of the component on the substrate.

8. The inspection apparatus according to claim 7, wherein
the detector is configured to detect an offset of a mounting position of the component on the substrate, and
the transmitter is configured to send offset information regarding the offset of the mounting position of the component as the defect information.

9. A processing apparatus, comprising:
an object processor configured to process an object;
a receiver configured to receive, when the inspection apparatus inspects whether or not the object processed by the object processor has a defect and sends defect information regarding the detected defect, the sent defect information;
a solving processor configured to perform solving processing based on solving measure information corresponding to the defect information; and
a transmitter configured to send content information regarding contents of the solving processing.

10. The processing apparatus according to claim 9, wherein
the transmitter is configured to send identification information for identifying the object processed by the processing apparatus after the solving processing.

11. The processing apparatus according to claim 9, wherein
the object processor is configured to print an electrically conductive portion on a substrate being the object, and
the inspection apparatus is configured to inspect a printing state of the electrically conductive portion on the substrate and send a defect of the printing state as the defect information.

12. The processing apparatus according to claim 11, wherein
the object processor includes
a screen, and
a squeegee configured to spread solder paste on the screen, to thereby transfer the solder paste on the substrate, and
the solving processor is configured to perform, as a solving measure corresponding to the defect information, at least one type of solving processing of cleaning of the screen, adjustment of an amount of the solder paste to be supplied to the screen, and correction of a position offset of the substrate.

13. The processing apparatus according to claim 9, wherein
the object processor is configured to mount a component on a substrate being the object, and
the inspection apparatus is configured to inspect a mounting state of the component on the substrate and send a defect of the mounting state as the defect information.

14. The processing apparatus according to claim 13, wherein
the object processor includes
a head configured to hold a component and mount the component on the substrate, and
a movement mechanism configured to move the head and the substrate relative to each other, and
the solving processor is configured to correct, as a solving measure against the defect, one of a relative position between the head and the substrate by the movement mechanism upon mounting of the component and a holding position of the component in the head.

15. An information processing apparatus, comprising:
a receiver configured to receive, when an inspection apparatus inspects whether or not an object processed by a processing apparatus has a defect and sends defect information regarding the detected defect, the sent defect information, and to receive, when the processing apparatus performs solving processing based on solving measure information corresponding to the defect information and sends content information regarding contents of the solving processing, the sent content information; and
a transmitter configured to send the received defect information to the processing apparatus and send the received content information to the inspection apparatus.

16. An object manufacturing apparatus, comprising:
an inspection apparatus; and
a processing apparatus, the inspection apparatus including
a detector configured to detect whether or not an object processed by a processing apparatus has a defect, and
a transmitter configured to send defect information regarding the defect detected by the detector to the processing apparatus, the processing apparatus including
an object processor configured to process the object,
a receiver configured to receive the defect information sent from the inspection apparatus,
a solving processor configured to perform solving processing based on solving measure information corresponding to the defect information, and
a transmitter configured to send content information regarding contents of the solving processing to the inspection apparatus.

17. A manufacturing method for an object, comprising:
processing the object by a processing apparatus;
inspecting, by an inspection apparatus, whether or not the object processed by the processing apparatus has a defect;
sending, by the inspection apparatus, defect information regarding the detected defect to the processing apparatus;
performing, by the processing apparatus, solving processing based on solving measure information corresponding to the defect information; and
sending content information regarding contents of the solving processing by the processing apparatus to the inspection apparatus.
